(19) United States
(12) Patent Application Publication
(10) Pub. No.: US 2024/0289094 A1
(43) Pub. Date: Aug. 29, 2024

(54) EFFICIENT MODULAR MULTIPLICATION MODULO 2^23 - 2^13 + 1

(71) Applicant: NXP B.V., Eindhoven (NL)

(72) Inventors: Joppe Willem Bos, Wijgmaal (BE); Yulia Kuzovkova, Darmstadt (DE)

(21) Appl. No.: 18/171,133

(22) Filed: Feb. 17, 2023

(51) Int. Cl. G06F 7/72

(52) U.S. Cl. CPC G06F 7/722

(57) ABSTRACT

A data processing system comprising instructions embodied in a non-transitory computer readable medium, the instructions for performing a modular multiplication of a first operand a and a second operand b in a DILITHIUM digital signature algorithm in a processor, the instructions, including: calculate S=c₁·2¹³−c₁+c₀ (mod q) wherein a·b₁=c₁·2²³+c₀, 0≤a·b₁<2³³, the modulus q=2²³−2¹³+1, and b=b₁·2¹³+b₀; calculate T=d₁−d₀·2¹⁰+d₀ (mod q) wherein d=a·b₀=d₁·2¹³+d₀, 0≤d<2³⁶, 0≤d₁<2²³, and 0≤d₀<2¹³; calculate c=S+T≡a·b·2⁻¹³ (mod q); and calculate a digital signature of a message using the calculated a·b.

### FIELD OF THE DISCLOSURE

Various exemplary embodiments disclosed herein relate to efficient modular multiplication modulo 2²³−2¹³+1.

### BACKGROUND

The new digital signature scheme Dilithium works with objects from the polynomial ring ( [symbol] /q [symbol] ) [X]/(X²⁵⁶+1) where arithmetic with the coefficients is done modulo q=2²³−2¹³+1.

### SUMMARY

A summary of various exemplary embodiments is presented below.

Various embodiments relate to a data processing system including instructions embodied in a non-transitory computer readable medium, the instructions for performing a modular multiplication of a first operand a and a second operand b in a Dilithium digital signature algorithm in a processor, the instructions, including: calculate S=c₁·2¹³−c₁+c₀ (mod q) wherein a·b₁=c₁·2²³+c₀, 0≤a·b₁<2³³, modulus q=2²³−2¹³+1, and b=b₁·2¹³+b₀; calculate T=d₁−d₀·2¹⁰+d₀ (mod q) wherein d=a·b₀=d₁·2¹³+d₀, 0≤d<2³⁶, 0≤d₁<2²³, and 0≤d₀<2¹³; calculate c=S+T≡a·b·2⁻¹³ (mod q); and calculate a digital signature of a message using the calculated a·b.

Various embodiments are described, wherein the instructions further include: calculate c=c−q once or twice, when c is greater than or equal to q and until c is less than q; and calculate c=c+q, when c is less than 0.

Various embodiments are described, wherein the calculation of S and T are performed in parallel.

Further various embodiments relate to a data processing system including instructions embodied in a non-transitory computer readable medium, the instructions for performing a modular multiplication of a first operand a and a second operand b in a Dilithium digital signature algorithm in a processor, the instructions, including: split the second operand b into b₀ and b₁, wherein b₁ is an upper 10 bits of the second operand b and b₀ is the lower 13 bits of the second operand b; calculate C=a·b₁; split C into c₀ and c₁, wherein c₁ is the upper 10 bits of C and c₀ is the lower 23 bits of C; calculate d=a·b₀; split d into d₀ and d₁, wherein d₁ is an upper 23 bits of d and d₀ is the lower 13 bits of d; calculate a·b·2⁻¹³=((c₁<<13)|d₀)−((d₀<<10)|c₁)+c₀+d₁ (mod q), wherein << indicates a left bit shift of a specified number of bits and | is bitwise-or operation; and calculate a digital signature of a message using the calculated a·b.

Various embodiments are described, wherein the instructions further include: calculate c=c−q once or twice, when c is greater than or equal to q and until c is less than q; and calculate c=c+q, when c is less than 0.

Various embodiments are described, wherein the calculation of c and d are performed in parallel.

Further various embodiments relate to a method for performing a modular multiplication of a first operand a and a second operand b in a Dilithium digital signature algorithm, including: calculating S=c₁·2¹³−c₁+c₀ (mod q) wherein a·b₁=c₁·2²³+c₀, 0≤a·b₁<2³³, modulus q=2²³−2¹³+1, and b=b₁·2¹³+b₀; calculating T=d₁−d₀·2¹⁰+d₀ (mod q) wherein d=a·b₀=d₁·2¹³+d₀, 0≤d<2³⁶, 0≤d₁<2²³, and 0≤d₀<2¹³; calculating c=S+T≡a·b·2⁻¹³ (mod q); and calculating a digital signature of a message using the calculated a·b.

Various embodiments are described, wherein the instructions further include: calculate c=c−q once or twice, when c is greater than or equal to q and until c is less than q; and calculate c=c+q, when c is less than 0.

Various embodiments are described, wherein the calculation of S and T are performed in parallel.

Further various embodiments relate to a method for performing a modular multiplication of a first operand a and a second operand b in a Dilithium digital signature algorithm, including: splitting the second operand b into b₀ and b₁, wherein b₁ is an upper 10 bits of the second operand b and b₀ is the lower 13 bits of the second operand b; calculating C=a·b₁; splitting C into c₀ and c₁, wherein c₁ is the upper 10 bits of C and c₀ is the lower 23 bits of C; calculating d=a·b₀; splitting d into d₀ and d₁, wherein d₁ is an upper 23 bits of d and d₀ is the lower 13 bits of d; calculating a·b·2⁻¹³=((c₁<<13)|d₀)−((d₀<<10)|c₁)+c₀+d₁ (mod q), wherein << indicates a left bit shift of a specified number of bits and | is bitwise-or operation; and calculating a digital signature of a message using the calculated a·b.

Various embodiments are described, wherein the instructions further include: calculating c=c−q once or twice, when c is greater than or equal to q and until c is less than q; and calculating c=c+q, when c is less than 0.

Various embodiments are described, wherein the calculation of c and d are performed in parallel.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an exemplary hardware diagram 100 for implementing an efficient modular multiplication method.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of lattice-based cryptographic systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with lattice-based cryptographic technologies, aspects of the present disclosure can be applied in other cryptographic systems that use modular multiplication.

The National Institute of Standards and Technology (NIST) post-quantum cryptographic standardization process selected Dilithium as a new digital signature standard. This digital signature scheme works with objects from the polynomial ring ( [symbol] /q [symbol] )[X]/(X²⁵⁶+1) where arithmetic with the coefficients is done modulo q=2²³−2¹³+1. It will be shown how one can adjust the bipartite modular multiplication method, disclosed in Marcelo E. Kaihara and Naofumi Takagi, Bipartite modular multiplication, CHES 2005 (Josyula R. Rao and Berk Sunar, eds.), LNCS, vol. 3659, Springer, Heidelberg, August/September 2005, pp. 201-210.

It will be described how to achieve multiplication modulo the prime 2²³−2¹³+1 that is a core operation in Dilithium. This approach is particularly useful for hardware implementations because its parts may be run in parallel and no multiplications are required in the reduction.

The new digital signature scheme Dilithium works with objects from the polynomial ring ( [symbol] /q [symbol] )[X]/(X²⁵⁶+1) where arithmetic with the coefficients is done modulo q=2²³−2¹³+1.

Montgomery multiplication is a method for performing fast modular multiplication. Montgomery multiplication relies on a special representation of numbers denoted by the Montgomery form. Montgomery reduction is used in Montgomery multiplication. The main idea behind Montgomery reduction is to change the representatives of the residue classes and change the modular multiplication accordingly such that the expensive division needed in the reduction is replaced by a cheaper multiplication. Let q be an odd w-bit integer. More precisely, instead of computing the modular multiplication a·b mod q, the Montgomery multiplication computes MontMul(a, b)=a·b·2^{-w} mod q. In order to use this modular multiplication method one needs to change the representation of the inputs. Given a w-bit modulus q, define the Montgomery form of an integer a to be ã=a·2^{w} mod q. This change of residue class ensures that the multiplication of two inputs in Montgomery form corresponds to the desired result in Montgomery form because:

$$MontMul ( \tilde{a} , \tilde{b} ) ≡ \tilde{a} \cdot \tilde{b} \cdot {2}^{- w} ≡ a \cdot {2}^{w} \cdot b \cdot {2}^{w} \cdot {2}^{- w} ≡ ( mod q ) .$$

This change of representation is performed because computing the Montgomery multiplication may be done efficiently on modern computer architectures where multiplications and exact divisions by powers of two correspond to shifting the number to the left or right, respectively.

Montgomery multiplication uses the pre-computed value

$$μ = - {q}^{- 1} mod {2}^{w} . \qquad ( 1 )$$

Then, one can compute the Montgomery reduction of an integer c such that 0≤c<q² using

$$MontRed ( c ) = ( c + q \cdot ( μ \cdot c mod {2}^{w} ) ) / {2}^{w} . \qquad ( 2 )$$

After this division by 2^{w}, the result has been reduced to at most 2q. This means a completely reduced result in [0, q] can be computed with an additional conditional subtraction.

The bipartite modular multiplication method of Kaihara is a method which enables the splitting of the multiplier into two parts: one using regular modular reduction and one using Montgomery reduction. These can be run in parallel.

Let q be an odd w-bit integer. Given two integers a, b∈ [symbol] _{q} where 0≤a, b<q the idea is to split one of the operands b such that b=b₁·2^{w/2}+b₀ where 0≤b₀, b₁<2^{w/2}. Now compute

$$S = ( a \cdot {b}_{1} ) mod q$$

using a regular modular reduction algorithm. Concurrently, one could compute

$$T = ( a \cdot {b}_{0} \cdot {2}^{- w / 2} ) mod q$$

using a Montgomery reduction approach. Finally combining the two gives

$$c ≡ ( S + T ) \qquad ( 3 )$$

$$≡ a \cdot {b}_{1} + a \cdot {b}_{0} \cdot {2}^{- w / 2} \qquad ( 4 )$$

$$≡ a \cdot ( {b}_{1} + {b}_{0} \cdot {2}^{- w / 2} ) \qquad ( 5 )$$

$$≡ a \cdot ( {b}_{1} \cdot {2}^{w / 2} + {b}_{0} ) \cdot {2}^{- w / 2} \qquad ( 6 )$$

$$≡ MontMul ( a , b ) ( mod q ) \qquad ( 7 )$$

where instead of multiplying with 2^{-w} one uses 2^{-w/2}.

It will now be shown how to compute an efficient modular multiplication with the prime used in the Dilithium post-quantum secure digital signature scheme. The prime proposed for usage in Dilithium is q=2²³−2¹³+1 and hence one has 2²³≡2¹³−1 (mod q). While this form will not help a lot when a number up to q² needs to be reduced to size q, it may help in the setting of the bipartite modular multiplication.

Let a, b∈ [symbol] _{q} where 0≤a, b<q. Write b=b₁·2¹³+b₀ where 0≤b₀<2¹³ and 0≤b₁<2¹⁰. It will be shown how to efficiently compute S=a·b₁ mod q. First, compute the multiplication part a·b₁=c₁·2²³+c₀ such that 0≤c<2³³, then:

$$S ≡ {c}_{1} \cdot {2}^{23} + {c}_{0} ≡ {c}_{1} \cdot ( {2}^{13} - 1 ) + {c}_{0} ≡ {c}_{1} \cdot {2}^{13} - {c}_{1} + {c}_{0} ( mod q ) .$$

$$S ≡ {c}_{1} \cdot {2}^{23} + {c}_{0} ≡ {c}_{1} \cdot ( {2}^{13} - 1 ) + {c}_{0} ≡ {c}_{1} \cdot {2}^{13} - {c}_{1} + {c}_{0} ( mod q ) .$$

$$S ≡ {c}_{1} \cdot {2}^{23} + {c}_{0} ≡ {c}_{1} \cdot ( {2}^{13} - 1 ) + {c}_{0} ≡ {c}_{1} \cdot {2}^{13} - {c}_{1} + {c}_{0} ( mod q ) .$$

When 0≤a, b<q then

$$0 \leq a \cdot {b}_{1} \leq {2}^{33} - {2}^{24} + {2}^{13} < {2}^{33} .$$

Because 0≤c₀<2²³ and 0≤c₁≤2¹⁰−2<2¹⁰ the following is obtained:

$$S \leq ( {2}^{10} - 2 ) \cdot {2}^{13} - ( {2}^{10} - 2 ) + ( {2}^{23} - 1 ) \leq {2}^{24} - {2}^{14} - {2}^{10} + 1 < 2 q < {2}^{24}$$

$$S \leq ( {2}^{10} - 2 ) \cdot {2}^{13} - ( {2}^{10} - 2 ) + ( {2}^{23} - 1 ) \leq {2}^{24} - {2}^{14} - {2}^{10} + 1 < 2 q < {2}^{24}$$

Hence, at most one further subtraction with q is needed to reduce S between 0 and q.

Similarly it will be shown how to efficiently compute the other part required by a bipartite multiplication using Montgomery multiplication. Let a, b∈ [symbol] _{q} where 0≤a, b<q. Write b=b₁·2¹³+b₀ where 0≤b₀<2¹³ and 0≤b₁<2¹⁰.

Next, use Montgomery multiplication to compute T≡d·2⁻¹³ ≡a·b₀·2⁻¹³ mod q First compute the multiplication part d=a·b₀=d₁·2¹³+d₀ such that 0≤d<2³⁶ and the bounds for dᵢ are 0≤d₁<2²³ and 0≤d₀<2¹³. The Montgomery pre-computed constant is μ≡q⁻¹ ≡1 mod 2¹³, note the sign difference compared to equation (1). This means that the Montgomery reduction is adjusted to MontRed(d)=(d−(d·μ mod 2¹³)·q)/2¹³ (compare with equation.(2)), and a conditional addition is needed instead of a conditional subtraction. This may be done using:

$$T ≡ d \cdot {2}^{- 13} ≡ ( d - ( d \cdot {μmod2}^{13} ) \cdot q ) / {2}^{13} ≡ ( d - {d}_{0} \cdot q ) / {2}^{13} ≡ ( {d}_{1} \cdot {2}^{13} + {d}_{0} - {d}_{0} \cdot ( {2}^{23} - {2}^{13} + 1 ) ) / {2}^{13} ≡ ( {d}_{1} \cdot {2}^{13} + {d}_{0} - {d}_{0} \cdot {2}^{23} + {d}_{0} \cdot {2}^{13} - {d}_{0} ) / {2}^{13} ≡ {d}_{1} - {d}_{0} \cdot {2}^{10} + {d}_{0} ( mod q )$$

$$T ≡ d \cdot {2}^{- 13} ≡ ( d - ( d \cdot {μmod2}^{13} ) \cdot q ) / {2}^{13} ≡ ( d - {d}_{0} \cdot q ) / {2}^{13} ≡ ( {d}_{1} \cdot {2}^{13} + {d}_{0} - {d}_{0} \cdot ( {2}^{23} - {2}^{13} + 1 ) ) / {2}^{13} ≡ ( {d}_{1} \cdot {2}^{13} + {d}_{0} - {d}_{0} \cdot {2}^{23} + {d}_{0} \cdot {2}^{13} - {d}_{0} ) / {2}^{13} ≡ {d}_{1} - {d}_{0} \cdot {2}^{10} + {d}_{0} ( mod q )$$

$$T ≡ d \cdot {2}^{- 13} ≡ ( d - ( d \cdot {μmod2}^{13} ) \cdot q ) / {2}^{13} ≡ ( d - {d}_{0} \cdot q ) / {2}^{13} ≡ ( {d}_{1} \cdot {2}^{13} + {d}_{0} - {d}_{0} \cdot ( {2}^{23} - {2}^{13} + 1 ) ) / {2}^{13} ≡ ( {d}_{1} \cdot {2}^{13} + {d}_{0} - {d}_{0} \cdot {2}^{23} + {d}_{0} \cdot {2}^{13} - {d}_{0} ) / {2}^{13} ≡ {d}_{1} - {d}_{0} \cdot {2}^{10} + {d}_{0} ( mod q )$$

$$T ≡ d \cdot {2}^{- 13} ≡ ( d - ( d \cdot {μmod2}^{13} ) \cdot q ) / {2}^{13} ≡ ( d - {d}_{0} \cdot q ) / {2}^{13} ≡ ( {d}_{1} \cdot {2}^{13} + {d}_{0} - {d}_{0} \cdot ( {2}^{23} - {2}^{13} + 1 ) ) / {2}^{13} ≡ ( {d}_{1} \cdot {2}^{13} + {d}_{0} - {d}_{0} \cdot {2}^{23} + {d}_{0} \cdot {2}^{13} - {d}_{0} ) / {2}^{13} ≡ {d}_{1} - {d}_{0} \cdot {2}^{10} + {d}_{0} ( mod q )$$

$$T ≡ d \cdot {2}^{- 13} ≡ ( d - ( d \cdot {μmod2}^{13} ) \cdot q ) / {2}^{13} ≡ ( d - {d}_{0} \cdot q ) / {2}^{13} ≡ ( {d}_{1} \cdot {2}^{13} + {d}_{0} - {d}_{0} \cdot ( {2}^{23} - {2}^{13} + 1 ) ) / {2}^{13} ≡ ( {d}_{1} \cdot {2}^{13} + {d}_{0} - {d}_{0} \cdot {2}^{23} + {d}_{0} \cdot {2}^{13} - {d}_{0} ) / {2}^{13} ≡ {d}_{1} - {d}_{0} \cdot {2}^{10} + {d}_{0} ( mod q )$$

$$T ≡ d \cdot {2}^{- 13} ≡ ( d - ( d \cdot {μmod2}^{13} ) \cdot q ) / {2}^{13} ≡ ( d - {d}_{0} \cdot q ) / {2}^{13} ≡ ( {d}_{1} \cdot {2}^{13} + {d}_{0} - {d}_{0} \cdot ( {2}^{23} - {2}^{13} + 1 ) ) / {2}^{13} ≡ ( {d}_{1} \cdot {2}^{13} + {d}_{0} - {d}_{0} \cdot {2}^{23} + {d}_{0} \cdot {2}^{13} - {d}_{0} ) / {2}^{13} ≡ {d}_{1} - {d}_{0} \cdot {2}^{10} + {d}_{0} ( mod q )$$

When 0≤a, b, <q then 0≤d₁<q and 0≤d₀<2¹³. This means that −2¹³(2¹⁰−1)<T<q, and at most one addition with q is needed to bring T to the range between 0 and q.

The only remaining step is to add S=c₁·2¹³−c₁+c₀ and T=d₁−d₀·2¹⁰+d₀ modulo q: this means c=S+T mod q. Because we know that d₀<2¹³ and c₁<2¹⁰ one can even further optimize this by computing:

$$c ≡ S + T ≡ a \cdot b \cdot {2}^{- 13} ≡ ( ( {c}_{1} ≪ 13 ) \vert {d}_{0} ) - ( ( {d}_{0} ≪ 10 ) \vert {c}_{1} ) + {c}_{0} + {d}_{1} ( mod q ) \qquad ( 8 )$$

where “<<” means a bit-shift to the left and “|” is the bitwise-or operation, a·b₁=c₁·2²³+c₀ and a·b₀=d₁·2¹³+d₀. Given the previous size estimates it is known that −q<c<2q, and hence one conditional addition and two conditional subtractions are needed when the results need to be between 0 and q. When c<0, calculate c=c+q. When q≤c, calculate c=c+q once or twice until c<q. Hence, the modular reduction can be done completely without multiplications as described in equation 8.

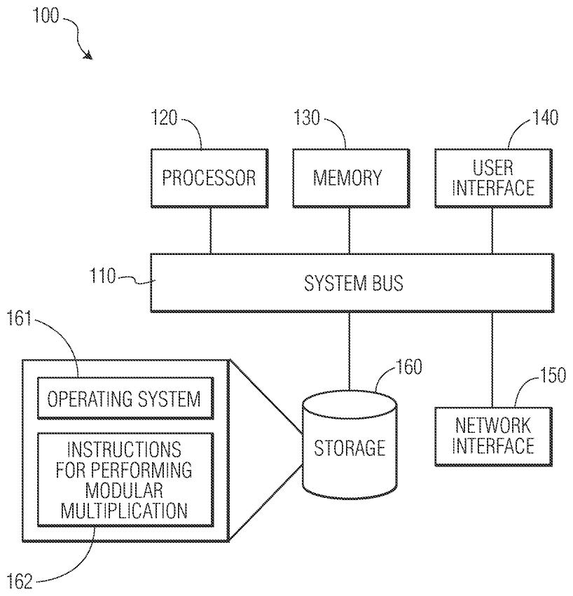

FIG. 1 illustrates an exemplary hardware diagram 100 for implementing an efficient modular multiplication method. As shown, the device 100 includes a processor 120, memory 130, user interface 140, network interface 150, and storage 160 interconnected via one or more system buses 110. It will be understood that FIG. 1 constitutes, in some respects, an abstraction and that the actual organization of the components of the device 100 may be more complex than illustrated.

The processor 120 may be any hardware device capable of executing instructions stored in memory 130 or storage 160 or otherwise processing data. As such, the processor may include a microprocessor, microcontroller, graphics processing unit (GPU), neural network processor, field programmable gate array (FPGA), application-specific integrated circuit (ASIC), or other similar devices.

The memory 130 may include various memories such as, for example L1, L2, or L3 cache or system memory. As such, the memory 130 may include static random-access memory (SRAM), dynamic RAM (DRAM), flash memory, read only memory (ROM), or other similar memory devices.

The user interface 140 may include one or more devices for enabling communication with a user such as an administrator. For example, the user interface 140 may include a display, a touch interface, a mouse, and/or a keyboard for receiving user commands. In some embodiments, the user interface 140 may include a command line interface or graphical user interface that may be presented to a remote terminal via the network interface 150.

The network interface 150 may include one or more devices for enabling communication with other hardware devices. For example, the network interface 150 may include a network interface card (NIC) configured to communicate according to the Ethernet protocol or other communications protocols, including wireless protocols. Additionally, the network interface 150 may implement a TCP/IP stack for communication according to the TCP/IP protocols. Various alternative or additional hardware or configurations for the network interface 150 will be apparent.

The storage 160 may include one or more machine-readable storage media such as read-only memory (ROM), random-access memory (RAM), magnetic disk storage media, optical storage media, flash-memory devices, or similar storage media. In various embodiments, the storage 160 may store instructions for execution by the processor 120 or data upon with the processor 120 may operate. For example, the storage 160 may store a base operating system 161 for controlling various basic operations of the hardware 100. The storage 160 may store instructions 162 for carrying out the efficient modular multiplication method described above.

It will be apparent that various information described as stored in the storage 160 may be additionally or alternatively stored in the memory 130. In this respect, the memory 130 may also be considered to constitute a “storage device” and the storage 160 may be considered a “memory.” Various other arrangements will be apparent. Further, the memory 130 and storage 160 may both be considered to be “non-transitory machine-readable media.” As used herein, the term “non-transitory” will be understood to exclude transitory signals but to include all forms of storage, including both volatile and non-volatile memories.

The system bus 110 allows communication between the processor 120, memory 130, user interface 140, storage 160, and network interface 150.

While the host device 100 is shown as including one of each described component, the various components may be duplicated in various embodiments. For example, the processor 120 may include multiple microprocessors that are configured to independently execute the methods described herein or are configured to perform steps or subroutines of the methods described herein such that the multiple processors cooperate to achieve the functionality described herein. Further, where the device 100 is implemented in a cloud computing system, the various hardware components may belong to separate physical systems. For example, the processor 120 may include a first processor in a first server and a second processor in a second server.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A data processing system comprising instructions embodied in a non-transitory computer readable medium, the instructions for performing a modular multiplication of a first operand a and a second operand b in a Dilithium digital signature algorithm in a processor, the instructions, comprising:
$$calculate S = {c}_{1} \cdot {2}^{13} - {c}_{1} + {c}_{0} ( mod q ) wherein a \cdot {b}_{1} = {c}_{1} \cdot {2}^{23} + {c}_{0} , \\ 0 \leq a \cdot {b}_{1} < {2}^{33} , modulus q = {2}^{23} - {2}^{13} + 1 , and b = {b}_{1} \cdot {2}^{13} + {b}_{0} ;$$
$$calculate T = {d}_{1} - {d}_{0} \cdot {2}^{10} + {d}_{0} ( mod q ) wherein d = a \cdot {b}_{0} = {d}_{1} \cdot {2}^{13} + {d}_{0} , \\ 0 \leq d < {2}^{36} , 0 \leq {d}_{1} < {2}^{23} , and 0 \leq {d}_{0} < {2}^{13} ;$$
calculate c=S+T≡a·b·2⁻¹³ (mod q); and
calculate a digital signature of a message using the calculated a·b.

2. The data processing system of claim 1, wherein the instructions further comprise:
calculate c=c−q once or twice, when c is greater than or equal to q and until c is less than q; and
$$calculate c = c + q , when c is less than 0.$$

3. The data processing system of claim 1, wherein the calculation of S and T are performed in parallel.

4. A data processing system comprising instructions embodied in a non-transitory computer readable medium, the instructions for performing a modular multiplication of a first operand a and a second operand b in a Dilithium digital signature algorithm in a processor, the instructions, comprising:
split the second operand b into b₀ and b₁, wherein b₁ is an upper 10 bits of the second operand b and b₀ is the lower 13 bits of the second operand b;
calculate C=a·b₁;
split C into c₀ and c₁, wherein c₁ is the upper 10 bits of C and c₀ is the lower 23 bits of C;
calculate d=a·b₀;
split d into d₀ and d₁, wherein d₁ is an upper 23 bits of d and d₀ is the lower 13 bits of d;
$$calculate a \cdot b \cdot {2}^{- 13} = ( ( {c}_{1} ≪ 13 ) \vert {d}_{0} ) - ( ( {d}_{0} ≪ 10 ) \vert {c}_{1} ) + {c}_{0} + {d}_{1} ( mod q ) ,$$
wherein << indicates a left bit shift of a specified number of bits and | is bitwise-or operation; and
calculate a digital signature of a message using the calculated a·b.

5. The data processing system of claim 4, wherein the instructions further comprise:
calculate c=c−q once or twice, when c is greater than or equal to q and until c is less than q; and
calculate c=c+q, when c is less than 0.

6. The data processing system of claim 1, wherein the calculation of c and d are performed in parallel.

7. A method for performing a modular multiplication of a first operand a and a second operand b in a Dilithium digital signature algorithm, comprising:
$$calculating S = {c}_{1} \cdot {2}^{13} - {c}_{1} + {c}_{0} ( mod q ) wherein a \cdot {b}_{1} = {c}_{1} \cdot {2}^{23} + {c}_{0} , \\ 0 \leq a \cdot {b}_{1} < {2}^{33} , modulus q = {2}^{23} - {2}^{13} + 1 , and b = {b}_{1} \cdot {2}^{13} + {b}_{0} ;$$
$$calculating T = {d}_{1} - {d}_{0} \cdot {2}^{10} + {d}_{0} ( mod q ) wherein d = a \cdot {b}_{0} = {d}_{1} \cdot {2}^{13} + {d}_{0} , \\ 0 \leq d < {2}^{36} , 0 \leq {d}_{1} < {2}^{23} , and 0 \leq {d}_{0} < {2}^{13} ;$$
calculating c=S+T≡a·b·2⁻¹³ (mod q); and
calculating a digital signature of a message using the calculated a·b.

8. The method of claim 7, wherein the instructions further comprise:
calculate c=c−q once or twice, when c is greater than or equal to q and until c is less than q; and
$$calculate c = c + q , when c is less than 0.$$

9. The method of claim 7, wherein the calculation of S and T are performed in parallel.

10. A method for performing a modular multiplication of a first operand a and a second operand b in a Dilithium digital signature algorithm, comprising:
splitting the second operand b into b₀ and b₁, wherein b₁ is an upper 10 bits of the second operand b and b₀ is the lower 13 bits of the second operand b;
$$calculating C = a \cdot {b}_{1} ;$$
splitting C into c₀ and c₁, wherein c₁ is the upper 10 bits of C and c₀ is the lower 23 bits of C;
$$calculating d = a \cdot {b}_{0} ;$$
splitting d into d₀ and d₁, wherein d₁ is an upper 23 bits of d and d₀ is the lower 13 bits of d;
$$calculating a \cdot b \cdot {2}^{- 13} = ( ( {c}_{1} ≪ 13 ) \vert {d}_{0} ) - ( ( {d}_{0} ≪ 10 ) \vert {c}_{1} ) + {c}_{0} + {d}_{1} ( mod q ) ,$$
wherein << indicates a left bit shift of a specified number of bits and | is bitwise-or operation; and
calculating a digital signature of a message using the calculated a·b.

11. The method of claim 10, wherein the instructions further comprise:
calculating c=c−q once or twice, when c is greater than or equal to q and until c is less than q; and
$$calculating c = c + q , when c is less than 0.$$

12. The method of claim 10, wherein the calculation of c and d are performed in parallel.
